(19) United States
(12) Patent Application Publication
(10) Pub. No.: US 2021/0027209 A1
(43) Pub. Date: Jan. 28, 2021

(54) AIRCRAFT SEAT CONFIGURATION MANAGEMENT SYSTEM AND METHOD

(71) Applicant: The Boeing Company, Chicago, IL (US)

(72) Inventor: Mithra Sankrithi, Edmonds, WA (US)

(73) Assignee: The Boeing Company, Chicago, IL (US)

(21) Appl. No.: 16/519,152

(22) Filed: Jul. 23, 2019

(51) Int. Cl. G06Q 10/02

(52) U.S. Cl. CPC G06Q 10/02; B64D 11/06

(57) ABSTRACT

A seat configuration management system and method for determining a seat configuration of an internal cabin of an aircraft include a seat configuration determination control unit that provides a portfolio of seat configuration options for a scheduled trip of the aircraft. The seat configuration determination control unit iteratively updates the portfolio of seat configuration options based on reservations for the scheduled trip. The seat configuration determination control unit determines a final seat configuration for the scheduled trip by, at least one part, iteratively updating the portfolio of seat configuration options.

### FIELD OF EMBODIMENTS OF THE DISCLOSURE

Embodiments of the present disclosure generally relate to seat configuration management systems and methods, and more particularly, to seat configuration management systems and methods that may be used to adaptively determine seat configurations for internal cabins of commercial aircraft.

### BACKGROUND OF THE DISCLOSURE

Commercial aircraft typically include an internal cabin that may be divided into numerous sections. A cockpit is generally separated from a passenger cabin, which may include a first class section, a business class section, an economy section, and the like. Each section within a passenger cabin may have a different spacing or pitch between rows of seats. For example, a first class section typically has a greater pitch between rows of seats as compared to an economy section. A number of seats abreast may also vary between classes. Further, aspects of the cabin may vary between certain sections. For example, taper section of a fuselage, proximity to exit doors, and the like may differ in relation to different sections.

Between flights of an aircraft, an operator may decide to reconfigure certain seating areas to adjust the pitch between certain rows of seats. For example, an operator may decide to change a row of an economy section into an economy plus section, or vice versa. The pitch between rows of the economy section may differ from the pitch between rows of the economy plus section. Seat pitch, positioning, and the like within certain areas of an internal cabin may be changed through various systems and methods, such as between flights of an aircraft.

In general, aircraft operators strive to provide a suitable configuration of seats (such as may include one more different class sections) to best serve passenger desires for various levels of service at various price points. Passenger demand for seating aboard an aircraft varies for different destinations and at different times. Passenger demand, bookings, and reservations for a particular flight may continually evolve, even until the point of departure of the flight.

However, a seat configuration for an aircraft is typically fixed. In certain instances, an airline may purchase numerous airplanes with the same interior arrangement and same seat count and class distribution. In other instances, an airline may purchase a handful of different pre-certified and pre-installed interior arrangements with different seat counts and class distributions, which may then be subsequently deployed judiciously on particular origin-destination city pairs according to typical market demands for those particular city pairs. Once an aircraft operator decides on an airplane with a particular interior arrangement, particular seat count, and particular seat configuration for a scheduled flight, the seat configuration typically remains in place, despite the potential for customer demand evolving up to the time of a flight. Some aircraft operators may find that re-configuring seats a short time before a flight departure, such as one or more hours before takeoff, is impractical. As such, while a particular flight may be fully booked, additional revenue for the flight may have been available, such as if certain passengers were willing to upgrade to a premium class of seating or if added seats could be made available, for example. In some cases, airlines deliberately overbook a flight and then pay overbooked passengers to take a later flight—a practice that can cause both spilled net revenue and passenger dissatisfaction related to the overbooking.

In general, an aircraft operator typically makes a predictive decision regarding how to arrange seats on the airplane anywhere from days to months to years prior to the flight, which may limit the ability to optimize revenues.

### SUMMARY OF THE DISCLOSURE

A need exists for a method that allows an aircraft operator to use dynamic data to determine a seat configuration for an aircraft. A need exists for a system and a method for quickly and efficiently determining a seat configuration for an internal cabin of a commercial aircraft.

With those needs in mind, certain embodiments of the present disclosure provide a seat configuration management system for determining a seat configuration of an internal cabin of an aircraft. The seat configuration management system includes a seat configuration determination control unit that provides a portfolio of seat configuration options for a scheduled trip (that is, flight) of the aircraft. The seat configuration determination control unit iteratively updates the portfolio of seat configuration options based on a time sequence of reservations for the scheduled trip. In at least one embodiment, the seat configuration determination control unit determines a final seat configuration for the scheduled trip by, at least one part, iteratively updating the portfolio of seat configuration options.

In at least one embodiment, a booking system is in communication with the seat configuration determination control unit. The reservations are input into the booking system.

In at least one embodiment, an aircraft seat configuration database is in communication with the seat configuration determination control unit. The aircraft seat configuration database stores seat configuration options data regarding the aircraft.

The portfolio of seat configuration options includes locations of seats within the internal cabin. The portfolio of seat configuration options may also include locations of monuments within the internal cabin.

In at least one embodiment, the seat configuration determination control unit iteratively updates the portfolio of seat configuration options until a seat reconfiguration deadline is reached.

The seat configuration determination control unit may adjust rows of a final seat configuration based on one or more defined seat assignments. The seat configuration determination control unit may assign one or more seat assignments after a final seat configuration is determined.

The seat configuration determination control unit may iteratively update the portfolio of seat configuration options at predetermined time intervals. The seat configuration determination control unit may iteratively update the portfolio of seat configuration options upon receipt of each of the reservations.

Certain embodiments of the present disclosure provide a seat configuration management method for determining a seat configuration of an internal cabin of an aircraft. The seat configuration management method includes providing, by a seat configuration determination control unit, a portfolio of seat configuration options for a scheduled trip of the aircraft, and iteratively updating, by the seat configuration determination control unit, the portfolio of seat configuration options based on reservations for the scheduled trip. In at least one embodiment, the seat configuration management method also includes determining, by the seat configuration determination control unit, a final seat configuration for the scheduled trip through said iteratively updating.

The seat configuration management method may include receiving the reservations from a booking system in communication with the seat configuration determination control unit. The seat configuration management method may also include storing seat configuration options data regarding the aircraft in an aircraft seat configuration database in communication with the seat configuration determination control unit.

### BRIEF DESCRIPTION OF THE DRAWINGS

FIG. 1 illustrates a perspective front view of an aircraft, according to an embodiment of the present disclosure.

FIG. 2A illustrates a top plan view of an internal cabin of an aircraft, according to an embodiment of the present disclosure.

FIG. 2B illustrates a top plan view of an internal cabin of an aircraft, according to an embodiment of the present disclosure.

FIG. 3 illustrates a schematic block diagram of a seat configuration management system, according to an embodiment of the present disclosure.

FIG. 4 illustrates a flow chart of a seat configuration management method, according to an embodiment of the present disclosure.

### DETAILED DESCRIPTION OF THE DISCLOSURE

The foregoing summary, as well as the following detailed description of certain embodiments, will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

Certain embodiments of the present disclosure provide a seat configuration management system and method that provide a portfolio of offerings at a distribution of pricing. In at least one embodiment, a seat configuration determination control unit iteratively updates the portfolio of offerings based on actual reservations of seats. For example, a method of configuring seats within an aircraft includes iteratively optimizing a hypothetical seat configuration based on real-time data, establishing a final seat configuration, and communicating the final seat configuration to a reconfiguration crew to implement.

Certain embodiments of the present disclosure provide a seat configuration management system and method that include a seat configuration determination control unit that offers a portfolio of seat configuration options for a scheduled trip (that is, flight) of an aircraft, analyzes reservations for the scheduled trip, and adaptively determines a seat configuration for the scheduled trip based on the reservations.

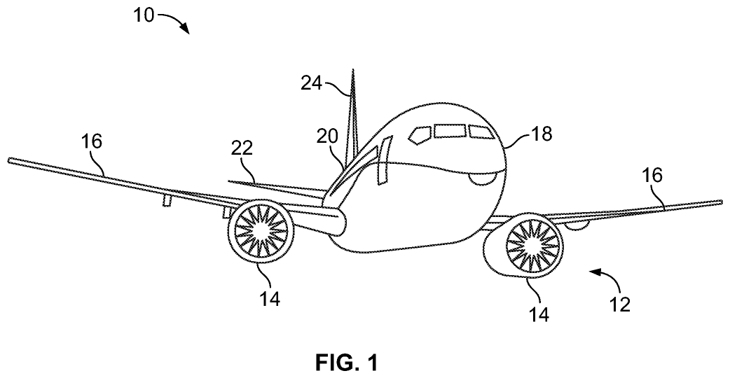

FIG. 1 illustrates a perspective top view of an aircraft, such as an aircraft 10, according to an embodiment of the present disclosure. The aircraft 10 includes a propulsion system 12 that may include two engines 14, for example. Optionally, the propulsion system 12 may include more engines 14 than shown. The engines 14 are carried by wings 16 of the aircraft 10. In other embodiments, the engines 14 may be carried by a fuselage 18 and/or an empennage 20. The empennage 20 may also support horizontal stabilizers 22 and a vertical stabilizer 24.

The fuselage 18 of the aircraft 10 defines an internal cabin, which may be defined by interior sidewall panels that connect to a ceiling and a floor. The internal cabin may include a cockpit, one or more work sections (for example, galleys, personnel carry-on baggage areas, and the like), one or more passenger sections (for example, first class, business class, and economy sections), and an aft section in which an aft rest area assembly may be positioned.

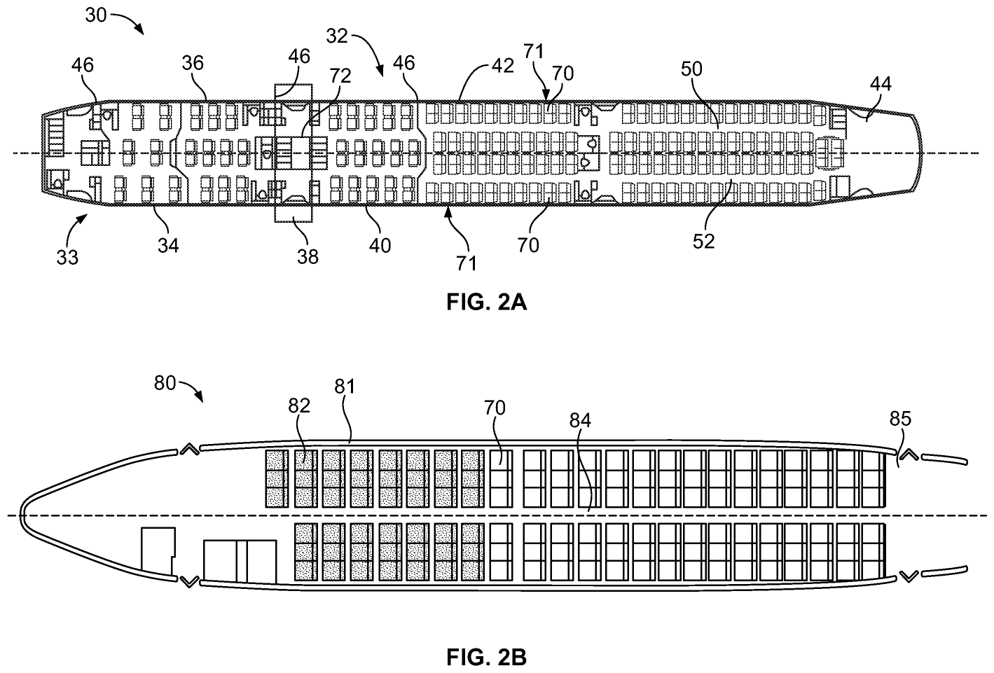

FIG. 2A illustrates a top plan view of an internal cabin 30 of an aircraft, according to an embodiment of the present disclosure. The internal cabin 30 may be within a fuselage 32 of the aircraft. For example, one or more fuselage walls may define an interior of the internal cabin 30. The interior of the internal cabin 30 is defined by sidewall panels that connect to a ceiling and a floor. The sidewall panels include lateral segments that connect to ceiling segments. The lateral segments define lateral wall portions, while the ceiling segments define at least portions of the ceiling within the internal cabin 30.

The internal cabin 30 includes multiple sections, including a front section 33, a first class section 34, a business class section 36, a front galley station 38, an expanded economy or coach section 40, a standard economy or coach section 42, and an aft section 44, which may include multiple lavatories and galley stations. It is to be understood that the internal cabin 30 may include more or less sections than shown. For example, the internal cabin 30 may not include a first class section, and may include more or less galley stations than shown. Each of the sections may be separated by a cabin transition area 46.

As shown in FIG. 2A, the internal cabin 30 includes two aisles 50 and 52 that lead to the aft section 44. Optionally, the internal cabin 30 may have less or more aisles than shown. For example, the internal cabin 30 may include a single aisle that extends through the center of the internal cabin 30 that leads to the aft section 44.

Seat assemblies 70 are positioned throughout the internal cabin 30. The seat assemblies 70 may be arranged in rows 71. Spacing or pitch between rows 71 of adjacent seat assemblies 70 may be changed, such as between flights.

As shown in FIG. 2A, the seat assemblies 70, monuments 72 (such as galleys and lavatories) are in a particular seat configuration that is arranged according to a seat configuration plan. The seat configuration plan specifies the locations of the various sections, the number of seat assemblies within the version, the pitch between rows of seat assemblies within the sections, and the like. The seat configuration within the internal cabin 30 may be changed to a different seat configuration, in which at least certain aspects (such as seat pitch between certain rows) differ from the previous seat configuration.

FIG. 2B illustrates a top plan view of an internal cabin 80 of an aircraft, according to an embodiment of the present disclosure. The internal cabin 80 may be within a fuselage 81 of the aircraft. For example, one or more fuselage walls may define the interior of the internal cabin 80. The internal cabin 80 includes multiple sections, including a main cabin 82 having passenger seat assemblies 70, and an aft section 85 behind the main cabin 82. It is to be understood that the internal cabin 80 may include more or less sections than shown.

The internal cabin 80 may include a single aisle 84 that leads to the aft section 85. The single aisle 84 may extend through the center of the internal cabin 80 that leads to the aft section 85. For example, the single aisle 84 may be coaxially aligned with a central longitudinal plane of the internal cabin 80.

FIG. 2B also shows a seat configuration in which the seat assemblies 70 are arranged according to a seat configuration plan. The seat configuration may be changed to a different seat configuration.

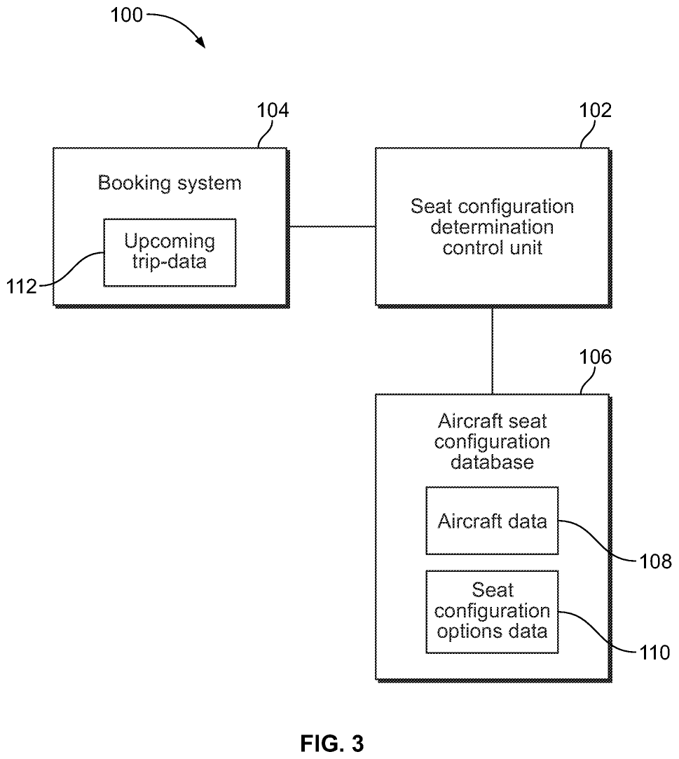

FIG. 3 illustrates a schematic block diagram of a seat configuration management system 100, according to an embodiment of the present disclosure. The seat configuration management system 100 includes a seat configuration determination control unit 102 in communication with a booking system 104, such as through one or more wired or wireless connections. The seat configuration determination control unit 102 is also in communication with an aircraft seat configuration database 106, such as through one or more wired or wireless connections. The seat configuration determination control unit 102 may be collocated with the booking system 104 and/or the aircraft seat configuration database 106. Optionally, the seat configuration determination control unit 102 may be remotely located from one or both of the booking system 104 and/or the aircraft seat configuration database 106.

The aircraft seat configuration database 106 stores aircraft data 108 for an aircraft that is scheduled for a trip, such as a flight of a commercial aircraft. For example, the aircraft data includes a size of the aircraft, space within the internal cabin, seat capacity within the internal cabin, and the like. The aircraft seat configuration database 106 also stores seat configuration options data 110 for the aircraft that is scheduled for the trip. In at least one embodiment, the seat configuration options data 110 stores all (or optionally a predetermined number of) possible seat configurations (including positions of seats, monuments, and the like within an internal cabin). For example, the internal cabin of the aircraft can have a first seat configuration in which 100 seats are at a first pitch, such as a 32 inch pitch, a second seat configuration in which 80 seats are at a second pitch, such as a 36 inch pitch, a third seat configuration in which 90 seats are at the first pitch, and 10 seats are at the second pitch, and so on. It is to be understood that these are merely simplified examples of seat configurations, and numerous possibilities exist.

The booking system 104 includes an electronic ticketing system, which individuals may gain access to through the internet, telephone, in person (such as at an airport), and/or the like. The booking system 104 allows customers to purchase tickets for an upcoming trip, and stores upcoming trip data 112. The upcoming trip data 112 includes information regarding seats sold, seats sold and available in various sections, inventory, and/or the like for one or more upcoming trips of an aircraft, such as upcoming flights of commercial aircraft.

As described herein, the seat configuration management system 100 is configured to determine a seat configuration of an internal cabin of an aircraft. The seat configuration management system 100 includes the seat configuration determination control unit 102 that provides a portfolio of seat configuration options for a scheduled trip of the aircraft. The seat configuration determination control unit 102 iteratively updates the portfolio of seat configuration options based on reservations (from customers) for the scheduled trip. The seat configuration determination control unit 102 determines a final seat configuration for the scheduled trip by iteratively updating the portfolio of seat configuration options.

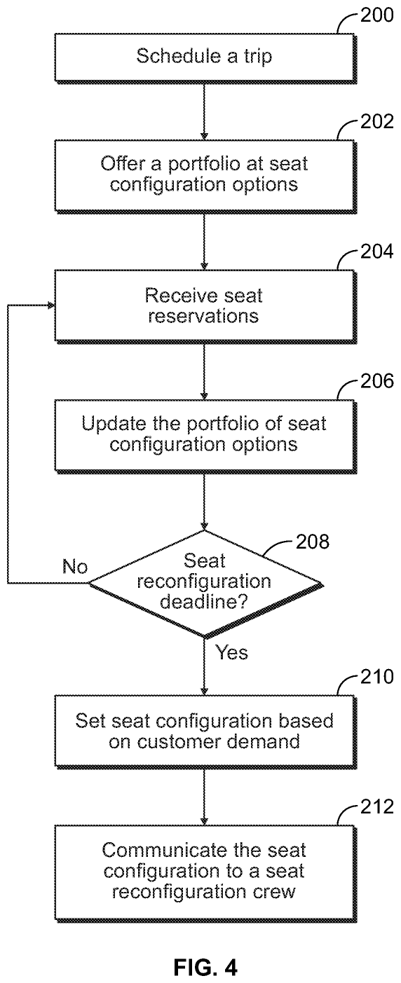

FIG. 4 illustrates a flow chart of a seat configuration management method, according to an embodiment of the present disclosure. Referring to FIGS. 3 and 4, at 200, a trip (such as a flight) for an aircraft (such as a commercial aircraft) is initially scheduled. For example, a trip for the aircraft is initially input into the booking system 104 at a predetermined time, such as 3-6 months before the scheduled date for the trip. The scheduled trip date is stored within the upcoming trip data 112 within the booking system 104.

At 202, a portfolio of seat configuration options are offered for the trip. The portfolio of seat configuration options are determined from the seat configuration options data 110 stored in the aircraft seat configuration database 106. For example, the seat configuration determination control unit 102 retrieves the seat configuration options data 110, which includes a first seat configuration for the aircraft, a second configuration data for the aircraft, . . . and an nth seat configuration for the aircraft. The seat configurations differ from one another. The seat configurations include offerings for seats for passengers for the scheduled trip. The portfolio of seat configuration options provides a wide variety of seat types at various price points. For example, the portfolio of seat configuration options include first seat types, such as economy seats at a first seat pitch at first prices, and second seat types, such as first class seats at a second seat pitch at second prices.

At 204, seat reservations are received. For example, customers book flight reservations through the booking system 104. The seat reservations are booked by customers at confirmed prices. The reservations are received in the booking system 104 as reservation data that is indicative of the actual reservations.

At 206, based on the seat reservations booked by customers, the seat configuration determination control unit 102 updates the portfolio of seat configuration options. For example, if a seat reservation is received for a first type of seat (such as an economy seat), then the seat configuration determination control unit 102 discards a seat configuration option that did not include any of the first type of seat. As an example, if a reservation is received for an economy seat, then the seat configuration determination control unit 102 eliminates a seat configuration option in which all seats within an internal cabin are first class seats.

Next, at 208, the seat configuration determination control unit 102 determines if a seat reconfiguration deadline is reached. The seat reconfiguration deadline is the time needed for the seats within the aircraft to be reconfigured based on a determined seat configuration before the scheduled trip. For example, a seat configuration or maintenance crew needs sufficient time to reconfigure the seats within an internal cabin before the scheduled trip. The seat reconfiguration deadline may be a predetermined time stored within a memory of the seat configuration determination control unit 102, the upcoming trip data 112 within the booking system 104, or the like. As example, the seat reconfiguration deadline may be 6 hours before a time of departure for the scheduled trip.

If, at 208, the seat configuration determination control unit 102 determines that the seat reconfiguration deadline has not been reached, the method returns to 204, at which seat reservations continue to be received. The seat configuration determination control unit 102 continues to update the portfolio of seat configuration options at 206 based on the actual seat reservations that are received. In this manner, the seat configuration determination control unit 102 iteratively updates the portfolio of seat configuration options based on real time customer demand (that is, actual seat reservations) up until the seat reconfiguration deadline is reached.

If, at 208, the seat configuration determination control unit 102 determines that the seat reconfiguration deadline has been reached, the method proceeds to 210, at which the seat configuration determination control unit 102 sets the seat configuration based on actual customer demand from the received seat reservations. At 212, the seat configuration determination control unit 102 then communicates the seat configuration, which has been set based on actual customer demand, to a seat configuration crew or the like, which then physically set the seat configuration within the internal cabin of the aircraft. For example, the seat configuration may be set using a combination of one or more of seat tracks, seat track fittings, repositioning of power and data wiring where needed, repositioning of passenger service units and elements thereof such as attendant call buttons, reading lights, air nozzles, signage such as fasten seatbelt signage, etc., and/or the like.

As described, the seat configuration management system 100 includes the seat configuration determination control unit 102 that offers the portfolio of seat configuration options for a scheduled trip of an aircraft, analyzes reservations for the scheduled trip, and adaptively updates the portfolio of seat configuration options and determines a seat configuration for the scheduled trip based on the reservations. The seat configuration determination control unit 102 iteratively optimizes a seat configuration for an internal cabin of an aircraft based on real time data, namely the seat reservations actually booked by customers over time. The final seat configuration is established after the seat reconfiguration deadline is reached.

In at least one embodiment, a customer may demand or request an assigned seat number at the time of reservation. The booking system 104 may offer such assigned seat number at a price premium. The final seat configuration may take account of such assigned seat location even if certain rows are adjusted to account for such assigned seat. As example, if a customer reserves an assigned seat at location 5A, one or more rows may be adjusted in the final seat configuration to account for that particular seat location at a particular class of seats. For example, if the customer reserved first class seat 5A, but the final seat configuration has only a single row of first class seats, then the first row of the first class section may be row 5. As such, the seat configuration determination control unit 102 may adjust rows of the final seat configuration, set at 210, based on defined seat assignments.

The booking system 104 may also offer reduced fares to customers who do not require an immediate seat assignment at the time of reservation. For example, the seat configuration determination control unit 102 may assign a seat assignment to a customer when the final seat configuration is determined and set at 210.

As an example, at an initial time before a flight departure time for a flight of an aircraft, the seat configuration determination control unit 102 retrieves the seat configuration options data 110 for the aircraft, and offers the portfolio of seat configuration options, which includes tickets for seats at a certain distribution of prices and comfort levels (for example, pitch, seat widths, types, and/or the like). For example, the portfolio of seat configuration options includes economy, business, first class, and the like. The seat configuration determination control unit 102 may also account for different types of constraints within the internal cabin, such as locations of monuments, a number of monuments (such as galleys and lavatories) for a certain number of passengers (for example, at least one lavatory for every 50 passengers), and the like. The constraints may include a number of seats abreast in a particular depending on class of service and stagger configuration(s), a possible number of seats depending on a size of the internal cabin, cross-aisles, galley complexes, lavatories, closets and other monuments for various seat configurations, defined locations for particular types of seats, emergency evacuation requirement compliance (doors and door ratings, zone exit limits, etc.), and the like. In at least one embodiment, constraints to a portfolio of seat configuration options include rules that preclude seat configuration options that violate certification rules, for example.

In at least one embodiment, the portfolio of seat configuration options includes a portfolio of variable price offerings of seats with variable seat attributes including seat pitch, legroom, recline range, seat width, armrest width, proximate window, proximate aisle, proximate cross-aisle, proximate bulkhead, seat location in an interior arrangement, handicap friendly features, and child friendly features. In at least one embodiment, the portfolio of variable price offerings include variable prices determined through probability of achieving at least one of increased revenue, increased profit, or increased load factor.

As can be appreciated, the seat configuration determination control unit 102 may offer different seat configuration options for an aircraft that may ultimately be mutually incompatible. For example, the initial portfolio of seat offerings may include a first seat configuration of all first class seats, and a second seat configuration of all economy class seats. Depending on which offers are accepted by the customers, ensuing iterations for the portfolio of seat configuration options are dynamically updated.

Consider the following non-limiting example. Suppose an internal cabin of a commercial aircraft is 670 inches long, exclusive of galleys, lavatories and cross-aisles. Suppose further that reconfiguration enablers allow for either 9 abreast upper economy class seating 3-3-3 or 10 abreast base economy class seating 3-4-3, and economy class seat pitch ranging anywhere from 29 inch pitch to 35 inch pitch. One possible seating arrangement, with 19 rows of 9 abreast seating at 35 inch pitch, would have a seat-count of 171. At the other end of the spectrum, another seating arrangement, with 23 rows of 10 abreast seating at 29 inch pitch, would have a seat-count of 230. A wide range of intermediate seat-counts, along with a very large portfolio of possible combinations of seat pitch and seats-abreast, is possible.

At a given point in time, such as two months before a flight, suppose that 50 assorted seats have already been reserved and sold. The seat configuration determination control unit 102 cooperates with the booking system 104 to offer an updated portfolio of seat configuration options with associated attributes (seat width, seat pitch) at various offer prices. For instance, the updated portfolio of seat configuration options may offer a basic width economy seat at a first pitch for a first price, a basic width economy seat at a second pitch for a second price, an expanded width economy seat at the first pitch for a third price, and so on. In at least one embodiment, once an offer is accepted for a particular seat, the pitch on connected seats in a seating module (triple or quad as the case may be, in this example), may be locked in the booking system 104 for further offers.

The portfolio of seat configuration options may be updated upon receipt of each seat reservation. Optionally, the portfolio of seat configuration options may be updated at predetermined time intervals, such as once every hour, 2 hours, 12 hours, 24 hours, or the like.

As noted, the portfolio of seat configuration options include seat configurations at different seat pitches. The portfolio of seat configuration options may also include various other aspects, such as seat width, seat type, privacy, entertainment options, and the like.

The portfolio of seat configuration options may also include a number and location of one or more monuments. For example, the portfolio of seat configuration options may include different locations for galleys, lavatories, closets, stowage units, partitions, and the like.

In at least one embodiment, the seat configuration determination control unit 102 may also account for constraints associated with reducing payload by revenue cargo reduction, baggage reduction, and/or passenger count reduction. As an example, the seat configuration determination control unit 102 may account for constraints, such as weather data (for example, headwinds) when setting a final seat configuration.

As used herein, the term “control unit,” “central processing unit,” “unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the seat configuration determination control unit 102 may be or include one or more processors that are configured to control operation thereof, as described herein.

The seat configuration determination control unit 102 is configured to execute a set of instructions that are stored in one or more data storage units or elements (such as one or more memories), in order to process data. For example, the seat configuration determination control unit 102 may include or be coupled to one or more memories. The data storage units may also store data or other information as desired or needed. The data storage units may be in the form of an information source or a physical memory element within a processing machine.

The set of instructions may include various commands that instruct the seat configuration determination control unit 102 as a processing machine to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of embodiments herein illustrate one or more control or processing units, such as the seat configuration determination control unit 102. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the seat configuration determination control unit 102 may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

Embodiments of the present disclosure provide systems and methods that allow large amounts of data to be quickly and efficiently analyzed by a computing device. Large amounts of data are being tracked and analyzed. The vast amounts of data are efficiently organized and/or analyzed by the seat configuration determination control unit 102, as described herein. The seat configuration determination control unit 102 analyzes the data in a relatively short time in order to quickly and efficiently output seat configuration determinations. A human being would be incapable of efficiently analyzing such vast amounts of data in such a short time. As such, embodiments of the present disclosure provide increased and efficient functionality, and vastly superior performance in relation to a human being analyzing the vast amounts of data. In short, embodiments of the present disclosure provide systems and methods that analyze thousands, if not millions, of calculations and computations that a human being is incapable of efficiently, effectively and accurately managing.

As described herein, embodiments of the present disclosure provide systems and methods that allow aircraft operators to use dynamic data to determine a seat configuration for an aircraft. Embodiments of the present disclosure provide systems and methods for quickly and efficiently determining a seat configuration for an internal cabin of an aircraft, such as a commercial aircraft, thereby increasing passenger comfort and revenue for the aircraft operator.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A seat configuration management system for determining a seat configuration of an internal cabin of an aircraft, the seat configuration management system comprising:
a seat configuration determination control unit that provides a portfolio of seat configuration options for a scheduled trip of the aircraft,
wherein the seat configuration determination control unit iteratively updates the portfolio of seat configuration options based on reservations for the scheduled trip.

2. The seat configuration management system of claim 1, wherein the seat configuration determination control unit determines a final seat configuration for the scheduled trip by, at least one part, iteratively updating the portfolio of seat configuration options.

3. The seat configuration management system of claim 1, further comprising a booking system in communication with the seat configuration determination control unit, wherein the reservations are input into the booking system.

4. The seat configuration management system of claim 1, further comprising an aircraft seat configuration database in communication with the seat configuration determination control unit, wherein the aircraft seat configuration database stores seat configuration options data regarding the aircraft.

5. The seat configuration management system of claim 1, wherein the portfolio of seat configuration options comprises one or both of locations or sizes of seats within the internal cabin.

6. The seat configuration management system of claim 5, wherein the portfolio of seat configuration options further comprises locations of monuments within the internal cabin.

7. The seat configuration management system of claim 1, wherein the seat configuration determination control unit iteratively updates the portfolio of seat configuration options until a seat reconfiguration deadline is reached.

8. The seat configuration management system of claim 1, wherein the seat configuration determination control unit adjusts rows of a final seat configuration based on one or more defined seat assignments.

9. The seat configuration management system of claim 1, wherein the seat configuration determination control unit assigns one or more seat assignments after a final seat configuration is determined.

10. The seat configuration management system of claim 1, wherein the seat configuration determination control unit iteratively updates the portfolio of seat configuration options at predetermined time intervals.

11. The seat configuration management system of claim 1, wherein the seat configuration determination control unit iteratively updates the portfolio of seat configuration options upon receipt of each of the reservations.

12. The seat configuration management system of claim 1, wherein the portfolio of seat configuration options includes a portfolio of variable price offerings of seats with variable seat attributes including seat pitch, legroom, recline range, seat width, armrest width, proximate window, proximate aisle, proximate cross-aisle, proximate bulkhead, seat location in an interior arrangement, handicap friendly features, and child friendly features.

13. The seat configuration management system of claim 12, wherein the portfolio of variable price offerings include variable prices determined through probability of achieving at least one of increased revenue, increased profit, or increased load factor.

14. A seat configuration management method for determining a seat configuration of an internal cabin of an aircraft, the seat configuration management method comprising:
providing, by a seat configuration determination control unit, a portfolio of seat configuration options for a scheduled trip of the aircraft; and
iteratively updating, by the seat configuration determination control unit, the portfolio of seat configuration options based on reservations for the scheduled trip.

15. The seat configuration management method of claim 14, further comprising determining, by the seat configuration determination control unit, a final seat configuration for the scheduled trip through said iteratively updating.

16. The seat configuration management method of claim 14, receiving the reservations from a booking system in communication with the seat configuration determination control unit.

17. The seat configuration management method of claim 14, further comprising storing seat configuration options data regarding the aircraft in an aircraft seat configuration database in communication with the seat configuration determination control unit.

18. The seat configuration management method of claim 14, wherein the portfolio of seat configuration options comprises locations of seats and monuments within the internal cabin.

19. The seat configuration management method of claim 14, wherein said iteratively updating continues until a seat reconfiguration deadline is reached.

20. The seat configuration management method of claim 14, further comprising adjusting, by the seat configuration determination control unit, rows of a final seat configuration based on one or more defined seat assignments.

21. The seat configuration management method of claim 14, further comprising assigning, by the seat configuration determination control unit, one or more seat assignments after a final seat configuration is determined.

22. A seat configuration management method for determining a seat configuration of an internal cabin of an aircraft, the seat configuration management method comprising:
storing seat configuration options data regarding the aircraft in an aircraft seat configuration database in communication with a seat configuration determination control unit;
receiving reservations for a scheduled trip of the aircraft from a booking system in communication with the seat configuration determination control unit;
providing, by the seat configuration determination control unit, a portfolio of seat configuration options for the scheduled trip of the aircraft, wherein the portfolio of seat configuration options comprises locations of seats and monuments within the internal cabin;
iteratively updating, by the seat configuration determination control unit, the portfolio of seat configuration options based on the reservations for the scheduled trip, wherein said iteratively updating continues until a seat reconfiguration deadline is reached; and
determining, by the seat configuration determination control unit, a final seat configuration for the scheduled trip through said iteratively updating.
